(19) United States
(12) Patent Application Publication
(10) Pub. No.: US 2026/0092827 A1
(43) Pub. Date: Apr. 2, 2026

(54) FLEXIBLE SENSOR FOR LEAK DETECTION IN LIQUID-COOLED INFORMATION HANDLING SYSTEMS

(71) Applicant: DELL PRODUCTS L.P., Round Rock, TX (US)

(72) Inventors: Sandor Farkas, Round Rock, TX (US); Michael Stumpf, Cedar Park, TX (US)

(21) Appl. No.: 18/901,968

(22) Filed: Sep. 30, 2024

(51) Int. Cl. G01M 3/16; G06F 1/20

(52) U.S. Cl. CPC G01M 3/16; G06F 1/20

(57) ABSTRACT

A leak sensor for monitoring a liquid cooing assembly of an information handling system includes a flexible dielectric substrate. A reference trace is formed on the flexible dielectric substrate. A first signal trace is formed on the flexible substrate substantially in parallel with a first portion of the reference trace. A second signal trace formed on the flexible substrate substantially in parallel with a second portion of the reference trace. The first and second signal traces are separated by insulation into separate regions on the flexible dielectric substrate. Electrically driving the first and second signal traces induces voltages on the first and second signal traces, the voltages correlated with an amount of liquid within the separate regions.

### FIELD OF THE DISCLOSURE

The present disclosure generally relates to information handling systems, and more particularly relates to detecting a coolant leak in a liquid-cooled information handling system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

A leak sensor for monitoring a liquid cooing assembly of an information handling system includes a flexible dielectric substrate. A reference trace is formed on the flexible dielectric substrate. A first signal trace is formed on the flexible substrate substantially in parallel with a first portion of the reference trace. A second signal trace formed on the flexible substrate substantially in parallel with a second portion of the reference trace. The first and second signal traces are separated by insulation into separate regions on the flexible dielectric substrate. Electrically driving the first and second signal traces induces voltages on the first and second signal traces, the voltages correlated with an amount of liquid within the separate regions.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a schematic diagram of an example leak sensor according to an embodiment of the present disclosure;

FIG. 2 is a schematic diagram of the leak sensor of FIG. 1 in conjunction with additional circuitry according to an embodiment of the present disclosure;

FIGS. 3A and 3B are perspective views of a leak sensor according to another embodiment of the present disclosure;

FIGS. 4A and 4B are perspective views of a leak sensor according to yet another embodiment of the present disclosure;

FIG. 5 is a perspective view of an active leak sensor according to still another embodiment of the present disclosure;

FIG. 6 is a perspective view of an array of interconnected leak sensors according an embodiment of the present disclosure.

FIG. 7 is a perspective view of an array of interconnected leak sensors operatively coupled with additional circuitry according to embodiment of the present disclosure;

FIG. 8 is a flow diagram of a method of monitoring for coolant leaks within a chassis of a liquid-cooled information handling system according to an embodiment of the present disclosure; and

FIG. 9 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Certain types of information handling systems, including desktops, laptops, servers, and the like, are sufficiently sized to permit cooling the systems using a liquid cooling apparatus or assembly. A liquid cooling assembly may include a pump, tubing, heat exchanger, coolant port, one or more CPU cold plates, one or more GPU cold plates, a memory heatsink, and fan. Operatively, the pump circulates a coolant such as water or other liquid (e.g., water plus additives) through the tubing and heat exchanger to the components of the information handling system, including memory, one or more CPUs and/or one or more GPU, as well as other components. The coolant circulates coolant—absorbing heat from the components and cooling the components via the cold plates—in a closed loop within the housing of the information handling system. Liquid cooling offers advantages over other types of cooling. Thus, as the processing power of information handling systems continues to increase, the use of liquid cooling is expected to become more common.

Notwithstanding the advantages of liquid cooling, there is the possibility that one or more components of the liquid cooling system may develop leaks over time due to vibration, thermal cycles, aging, misalignment of heat exchangers or cold plates, or the like. Any leak that exposes the components of the information handling system to liquid can cause corrosion or damage to the circuitry within the system's housing. In certain arrangements, a leak occurring in one information handling system also may damage one or more nearby information handling systems if the systems are sufficiently close to one another. For example, a leak may occur in one of multiple servers stacked on a vertical rack (an increasingly common configuration). If the leak is not detected early enough, the coolant may spill out of one server and adversely affect one or more servers below it on the vertical rack.

A conventional device for detecting the unwanted presence of liquid is a leak detection rope. A leak detection rope has several drawbacks, however, especially in the context of detecting liquid within the narrow confines typical of an information handling system chassis. It is difficult, for example, to ensure that the leak detection rope touches the planar surface of a mainboard in the chassis. Given the typical thickness of leak sensor ropes, it is difficult to fit a leak detection rope within tight spaces. It is also difficult to ensure that there are not severe bends in the leak detection rope when positioning it. A severe bend, for example, may cause an electrical short that generates a false alarm when in fact there is no leak. Notwithstanding that leak detection ropes are relatively costly, they typically provide relatively poor sensitivity. Leak detection ropes tend not to readily detect minute leaks, for example. Ordinarily, a leak detection rope operates merely as an on-off switch and exhibits poorly defined threshold detection and resistance. A leak detection rope typically requires surface braiding that acts nearly as an insulator. Moreover, temperature and other factors can change the operating characteristic of leak detection rope.

The present disclosure provides a flexible leak sensor that overcomes the limitations of leak detection ropes. The flexible leak sensor may be thin as well as flexible, can take various shapes (e.g., daisy chain,, tree, forked), and readily fits within the confined spaces of an information handling system chassis. The flexible leak sensor is neither temperature nor humidity sensitive. The leak sensor provides greater sensitivity, detecting even minute leaks of coolant.

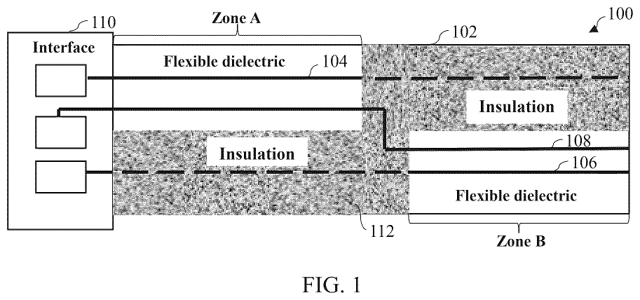

FIG. 1 illustrates a leak sensor 100 according to an embodiment of the present disclosure. Illustratively, leak sensor 100 includes flexible dielectric substrate 102, first signal trace 104, second signal trace 106, reference trace 108, and electrical interface 110. First signal trace 104, second signal trace 106, and reference trace 108 are formed on one side of flexible dielectric substrate 102 and communicatively couple with interface 110. The opposing side of flexible dielectric substrate 102, in certain embodiments, functions as a ground plane.

First signal trace 104 extends substantially in parallel with, and spaced apart from, one portion of reference trace 108 on flexible dielectric substrate 102. Second signal trace 106 extends substantially in parallel with, and spaced apart from, another portion of reference trace 108 on flexible dielectric substrate 102. An example geometry of the formation of the traces on flexible dielectric substrate 102 is 4 mil traces and 10 mil spacing, but various geometries are possible. For example, tighter spacing may enhance sensitivity

First signal trace 104 and second signal trace 106 are insulated by insulation 112, which covers portions of each of the signal traces. Insulation 112 may be provided by an insulating solder mask, which creates separate regions of flexible dielectric substrate 102 (illustratively identified as zone A and zone B) and which, at least partially, impedes the flow of liquid between the separate regions. Optionally, a silkscreen barrier may extend between the separate regions.

First signal trace 104, second signal trace 106, and reference trace 108 are conductive traces. Operatively, first signal trace 104 and reference trace 108, substantially in parallel with one another, form a differential pair. Second signal trace 106 substantially in parallel with reference trace 108 operatively form another differential pair. Leak sensor 100 may couple with additional circuitry that drives first and second signal traces 104 and 106 and that processes the distinct signals generated by the respective differential pairs formed by the first and second signal traces in conjunction with reference trace 108. The distinct signals may be correlated with an amount of liquid within separate regions of the chassis of an information handling system, the regions corresponding to the respective portions of flexible dielectric substrate 102 (zone A and zone B). The additional circuitry, in certain embodiments, forms a voltage divider with each of the differential pairs and measures the respective impedances associated with each. In other embodiments, a voltage divider measure capacitances associated with each differential pair. Impedance and capacitance can be measured to indicate an amount of liquid within the separate regions of the chassis of an information handling system. A significant difference between the impedance or capacitance of one zone and that of the other zone indicates a potential coolant leak in one of the zones, as described in greater detail below. Trace amounts of water due to humidity or moisture, by contrast, are not sufficient to trigger a warning of a potential leak.

First signal trace 104 and second signal trace 106 may be driven by alternating-current (AC) or direct-current (DC) signals, the former offering certain advantages over the latter. The differential pairs formed by first and second signal traces 104 and 106 in conjunction with reference trace 108, when electrically driven, provide response signals that can be measured to determine the impedances or capacitances of each differential pair. A differential pair's impedance (or capacitance) changes if the differential pair comes in contact with liquid. For example, water tends to be slightly conductive and thus lowers the impedance but has a dielectric constant that typically increases the capacitance. Thus, leak sensor 100 may be coupled with circuitry that electrically drives the traces and processes signals generated on the traces in response. A detected change in the magnitude of the generated signals may indicate a potential coolant leak.

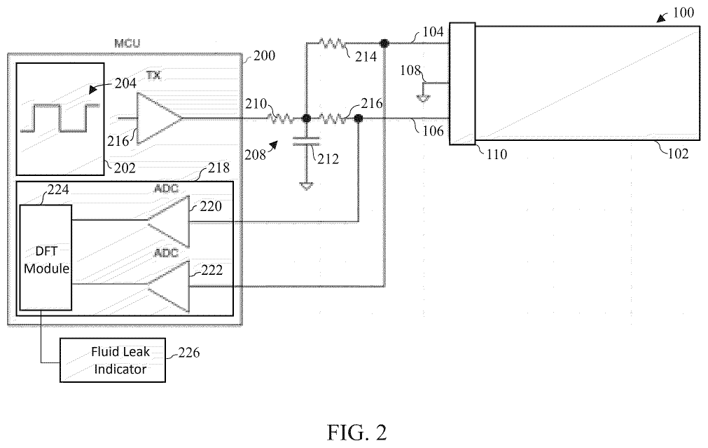

FIG. 2 illustrates certain operative aspects of leak sensor 100 operating in conjunction with additional circuitry according to an embodiment of the present disclosure. Leak sensor 100 coupled with the additional circuitry monitors a liquid-cooled information handling system for potential coolant leaks. The additional circuitry acts as a control unit with respect to leak sensor 100 and may be implemented in a microcontroller unit (MCU), such as MCU 200. MCU 200 includes signal generator 202, which generates pulse width modulation (PWM) signal 204, and transmitter 206 which outputs the PWM signal to resistor-capacitor (RC) low-pass filter 208. RC low-pass filter 208 is formed by resistor 210 and capacitor 212. RC low-pass filter 208 converts PWM signal 204 to an alternating-current (AC) signal.

Operatively, the AC signal drives the differential pairs formed by first signal trace 104 in parallel with reference trace 108 and second signal trace 106 in parallel with reference trace 108. The AC signal passes through RC low-pass filter 208 and resistor 214, which jointly form a voltage divider when connected to interface 110, to drive conductive trace 104. The same AC signal passes through RC low-pass filter 208 and resistor 216, which also jointly form a voltage divider circuit when connected to interface 110, to drive conductive trace 106. Driven by the same AC signal, each of the differential pairs generate signals in response. The generated signals are voltages.

MCU 200 includes signal processor 218, which illustratively includes analog-to-digital converter (ADC) 220 and ADC 222. ADC 222 samples the signal voltage of differential pair formed by first signal trace 104 and reference trace 108. ADC 220 samples the signal voltage of the differential pair formed by second signal trace 106 and reference trace 108. Signal processor 218, in certain embodiments, includes discrete Fourier transform (DFT) module 224. DFT module 224 is configured to perform discrete Fourier transformations to measure the signal voltages of first and second signal traces 104 and 106.

In certain embodiments, a portion of first signal trace 104 and a portion of second signal trace 106 are not covered by insulation 112, and hence are exposed. To mitigate corrosion, the traces may be plated using, for example, gold plating. The impedance of the differential pair formed by first signal trace 104 and reference trace 108 changes when the exposed portion of the first signal trace comes into contact with, or is in close proximity to, a liquid such as a coolant which is at least moderately conductive. Likewise, the impedance of the differential pair formed by second signal trace 104 and reference trace 108 changes when the exposed portion of the second signal trace comes into contact with, or is in close proximity to, the liquid. The impedances can be measured with the voltage divider circuits formed, respectively, by RC low-pass filter 208 and resistor 214 when connected with first signal trace 104 and by RC low-pass filter 208 and resistor 216 when connected to second signal trace 106 via interface 110. ADC 222 and ADC 220 sample the voltages on first signal trace 104 and second signal trace 106, respectively. Based on the sampled voltages, DFT module 224 measures the peak voltages on first signal trace 104 and second signal trace 106, changes in which correlate to the impedances of the respective differential pairs associated with the signal traces.

Signal processor 218 may include firmware configured to compare the impedances of the respective differential pairs. Given that a typical coolant is at least slightly conductive, a drop in the impedance of one differential pair relative to the other is an indication of a potential coolant leak. Moreover, given that the differential pairs associated with first and second signal traces lie in different regions of leak sensor 100 (e.g., zone A or zone B), it follows that the location of the potential leak can be identified based on which of the differential pairs is associated with the drop in impedance. In other embodiments, signal processor 218 may include firmware configured to compare the impedances of the respective differential pairs to a predetermined and electronically stored predetermined threshold. If one of the impedances is less than the predetermined threshold, then signal processor 218 may be configured to identify which of the differential pairs is associated with the decreased impedance and thus determine a location of the potential coolant leak responsible. To handle the unlikely event that a large coolant leak affects both differential pairs at the same time, signal processor 218 configured to also track the trend of the impedances over time. Slow changes (e.g., those occurring within a few seconds) indicate humidity variations within the chassis of the information handling system, but conversely, rapid changes with respect to both differential pairs indicate a large leak affecting both regions corresponding to the respective differential pairs.

In any case, MCU 200 may be configured to respond to signal processor 218's detecting a potential coolant leak by signaling fluid leak indicator 226, which responds in turn by generating a notification to indicate the possible occurrence of a fluid leak within the chassis of the information handling system. In some embodiments, fluid leak indicator 226 generates the indication by initiating an audible alarm embedded in or communicatively coupled with the information handling system. Fluid leak indicator 226, in other embodiments, initiates a visual message on a display screen of the information handling system. In still other embodiments, fluid leak indicator 226 includes a transmitter that generates the notification of a potential fluid leak to a remote site. The transmitter may be a wireline and/or wireless transmitter for conveying the notification of the potential fluid leak to a remotely situated user. With a wireless transmitter, fluid leak indicator 226 may convey a wireless notification of the potential fluid leak to the remotely situated user.

The signal generated by signal generator 202 to drive conductive traces 104 and 106 of can be selected to optimize signal strength such that signal processor 218's capacity for discriminating between, for example, a high humidity level and a coolant leak is enhanced. The spacing of the conductive traces 104 and 106, respectively, with respect to reference trace 108 can be selected to optimize signal strength such that signal processor 218's capacity for discriminating between a high humidity level and a coolant leak is likewise increased.

Although conductive traces 104 and 106 may be driven with a direct-current (DC) signal there are certain advantages with using an alternating-current (AC) signal. In accordance with at least one embodiment, for example, even at 35 degrees Celsius and 90% relative humidity, the high level of humidity can be differentiated from a coolant leak event with a measurement difference of at least three decibels (dB).

In some embodiments, leak sensor 100 is configured to detect a potential coolant leak based on the capacitances associated with the differential pairs formed by first and second signal traces 104 and 106 substantially in parallel with reference trace 108. Leak sensor 100 is configured accordingly without exposed portions of first and second signal traces 104 and 106. This may lessen performance but has the advantage of higher dust resistance. Additionally, there is a cost savings in that there is no need for plating first and second signal traces 104 and 106 given that there are no exposed portions that are vulnerable to corrosion.

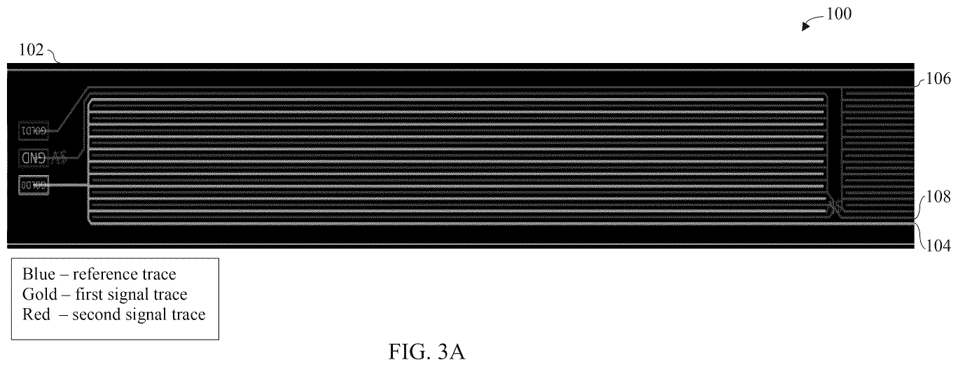

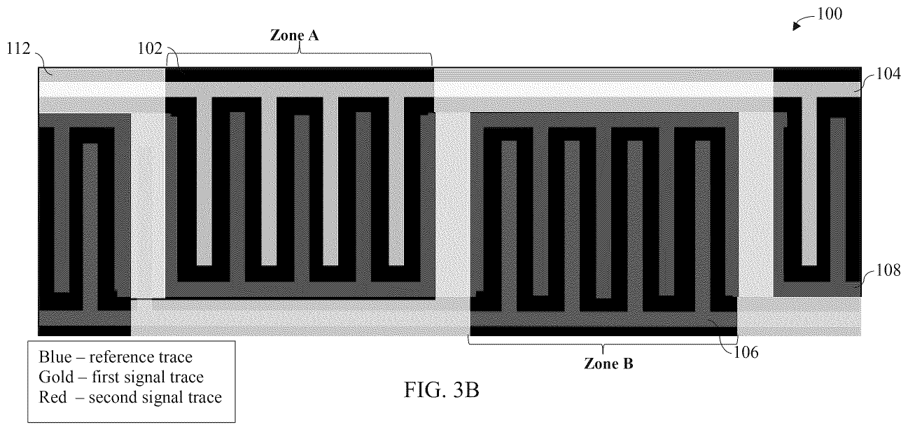

FIGS. 3A and 3B illustrate an arrangement of first and second signal traces 104 and 106 relative to reference trace 108 formed on flexible dielectric substrate 102 according to an embodiment of the present disclosure. As shown in FIG. 3A, first signal trace 104, second signal trace 106, and reference trace 108 are each configured in a comb-like structure, the structure having multiple finger-like extensions. FIG. 3B provides a close-up view, showing that the finger-like extensions of first signal trace 104 and second signal trace 106 are interdigitated with, and spaced apart an equidistant from, the finger-like extensions of reference trace 108. Illustratively, insulation 112 zigzags between separate regions of flexible dielectric substrate 102. The separate regions are identified as zones A and B. Insulation 112 in certain embodiments may be provided by a solder mask and silkscreen barrier.

Alternating zones occupied either by first signal trace 104 and reference trace 108 substantially in parallel to one another, or by second signal trace 106 substantially in parallel with reference trace 108, may extend along the length of flexible dielectric substrate 102. The alternating zones are insulated by insulation 112. With the illustrated arrangement, each zone is almost entirely occupied either by first signal trace 104 substantially in parallel with reference trace 108 or by second signal trace 106 substantially in parallel with reference trace 108. The arrangement enables detection of changes in ambient humidity while preserving the sensitivity of leak sensor 100. With leak sensor 100 operatively coupled with circuitry such as that described with respect to FIG. 2 (e.g., MCU 200), a coolant leak may be detected, for example, when the collection of coolant increases in size and flows from one zone to another.

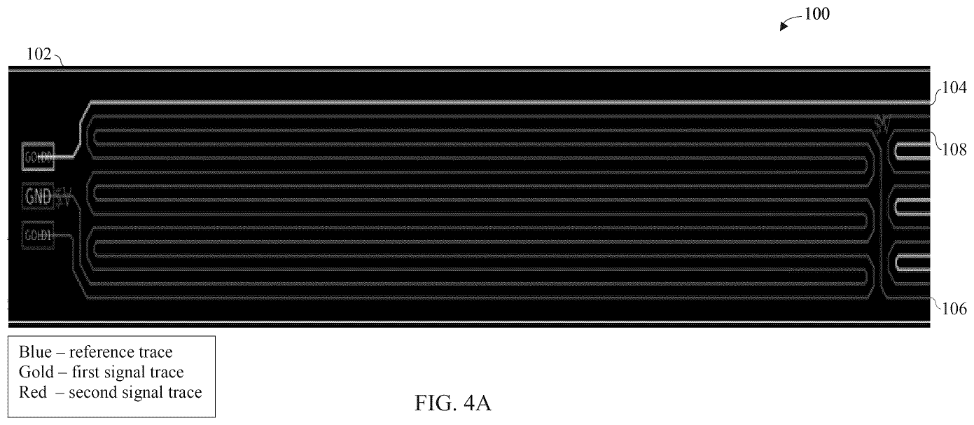

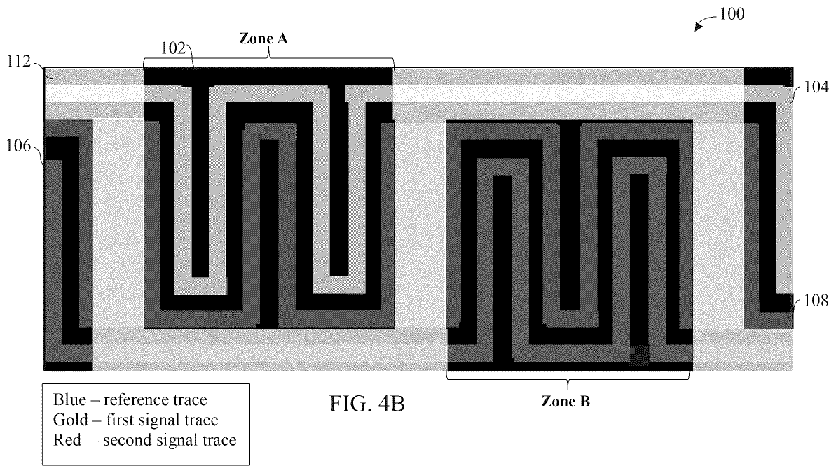

FIGS. 4A and 4B illustrate another arrangement of first and second signal traces 104 and 106 relative to reference trace 108 formed on flexible dielectric substrate 102 according to an embodiment of the present disclosure. FIG. 4A shows that first signal trace 104, second signal trace 106, and reference trace 108 each extend along continuous serpentine paths on flexible dielectric substrate 102. The respective paths each form a repeating pattern of extensions. FIG. 4B provides a close-up view of the extensions. As shown, each extension turns back on itself, with the extensions of reference trace 108 alternating with the extensions of first signal trace 104 and second signal trace 106. The extensions of first signal trace 104 alternating with those of reference trace 108 occupy one region of flexible dielectric substrate 102 (identified as zone A), and the extensions of second signal trace 106 alternating with those of reference trace 108 occupy another distinct region (identified as zone B). With each trace extension turning back on itself in the opposite direction, common mode noise cancels out when each trace is electrically driven. The arrangement yields lessens sensitivity but also lower noise using a wider detection pattern.

In other embodiments, leak sensor 100 may be implemented as two-layer sensor with the sensor pattern formed with first signal trace 104, second signal trace 106, and reference trace 108 on flexible dielectric substrate 102 being one layer, and on the opposite side of the substrate, a similar patter being the second layer. The second layer thus includes a second reference trace extending substantially in parallel with a third signal trace and a fourth signal trace. The reference trace and respective signal traces formed on the second layer also may be insulated by insulation (e.g., solder mask) and form separate regions of the second layer.

In yet other embodiments, leak sensor 100 may be implemented as a three-layer sensor. Two outer layers may each include signal traces substantially in parallel with a reference trace and separated into distinct regions by insulation on a flexible dielectric substrate. A third, middle layer may extend between the two outer layers. The middle layer may form a ground plane.

Optionally, in any of the various arrangements described, the distinct regions of the flexible dielectric substrate formed by isolating the signal traces and reference trace with insulation may be covered by a moisture-wicking material. The moisture-wicking material covering each distinct region draws a liquid, such as a coolant, into a region and thus accelerates the speed with which the liquid is detected with the leak sensor.

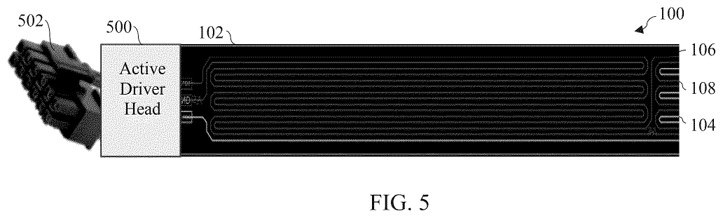

FIG. 5 illustrates another embodiment of leak sensor 100. In accordance with the embodiment, leak sensor 100 is an active leak sensor and includes flexible dielectric substrate 102, with first and second signal traces 104 and 106 extending substantially in parallel with reference trace 108 formed on the flexible dielectric substrate. Additionally, leak sensor 100 includes active driver head 500. Active driver head 500 operates to drive signal traces 104 and 106. In certain embodiments, as shown, active driver head 500 is configured to connect with Platform Infrastructure Connectivity Power (PICPWR) connector 502 and is Data Center Modular Hardware System (DC-MHS) compliant to interface with a host processor module.

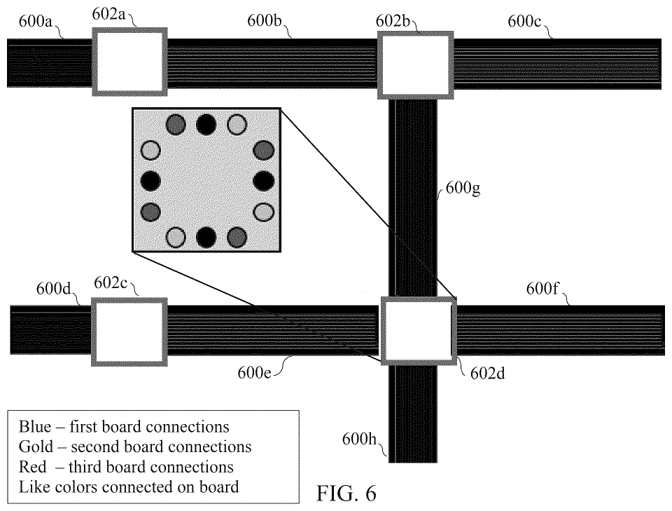

In various embodiments, leak sensor 100 may operatively couple with other leak sensors similarly formed with signal and reference traces formed on flexible dielectric substrates. In certain embodiments, each of the leak sensors may be implemented as a flexible printed circuit board (PCB) that connects with one or more other flexible PCBs using board-to-board connectors, as illustrated in FIG. 6. Flexible PCBs 600a, 600b, 600c, 600d, 600e, 600f, 600g, and 600h are interconnected by board-to-board connectors 602a, 602b, 602c, and 602d. The figure insert shows an expanded view of representative board-to-board connector 602d.

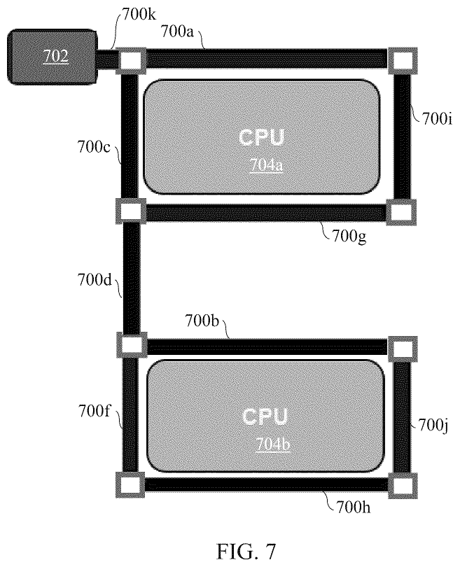

FIG. 7 illustrates multiple interconnected leak sensors 700a, 700b, 700c, 700d, 700e, 700f, 700g, 700h, 700i, 700j, and 700k implemented as flexible PCBs according to an embodiment of the present disclosure. Leak sensor 700k is operatively coupled to active circuitry 702. Like the circuitry described with reference to FIG. 2, circuitry 702 may include a signal generator, signal processor, and other circuitry. Leak sensors 700a-700k may be passive leak sensors but can be driven by circuitry 702 though the circuitry's connection with leak sensor 700k. The interconnections that operatively couple multiple leak sensors allow leak sensors 700a-700k to be configured in various shapes for monitoring an information handling system chassis for coolant leaks. As illustrated in FIG. 7, leak sensors 700a-700k can be positioned to monitor CPU 704a and CPU 704b. Leak sensors 700a-700k can be configured in various other arrangements to monitor other regions and other components within the chassis of an information handling system, including for example, arranging the leak sensors in a daisy chain, a tree structure, or various other arrangements.

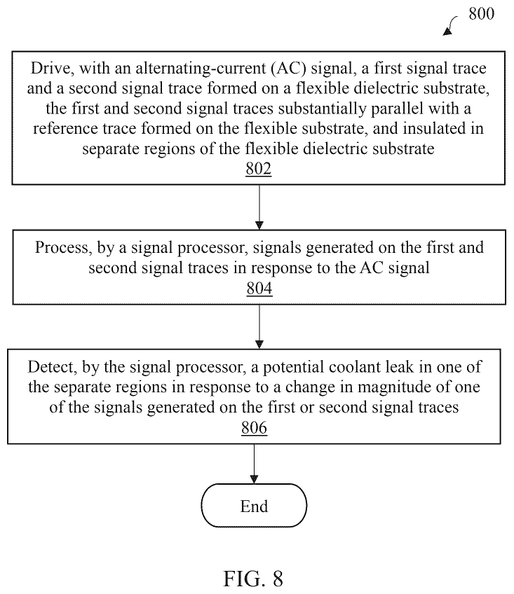

FIG. 8 is a flow diagram of method 800 for monitoring the chassis of an information handling system for a coolant leak according to an embodiment of the present disclosure. It will be readily appreciated that not every method step set forth in this flow diagram is always necessary, and that certain steps of the methods may be combined, performed simultaneously, in a different order, or perhaps omitted, without varying from the scope of the disclosure. Method 800 may be performed using a leak sensor such as leak sensor 100 described with reference to FIGS. 1-7.

At step 802, a first signal trace and a second signal trace are electrically driven by an AC signal. The first and second signal traces are formed on a flexible dielectric substrate. The first and second signal traces extend substantially parallel with a reference trace also formed on the flexible dielectric substrate. Insulation separates the first and second signal traces in separate regions of the flexible dielectric substrate. The insulation, in accordance with certain embodiments, creates separate regions of the flexible dielectric substrate.

At block 804, signals generated on the first and second signal traces in response to the AC signal are processed by a signal processor. The signals are conveyed to the signal processor via an interface of the flexible dielectric substrate.

At block 806, a potential coolant leak in one of the separate regions is detected by the signal processor. The potential coolant leak is detected in response to a change in magnitude of one of the signals generated on the first or second signal traces. A change in magnitude of signals generated on both the first and second signal traces, the signal processor detects that a potential coolant leak has occurred in both of the separate regions.

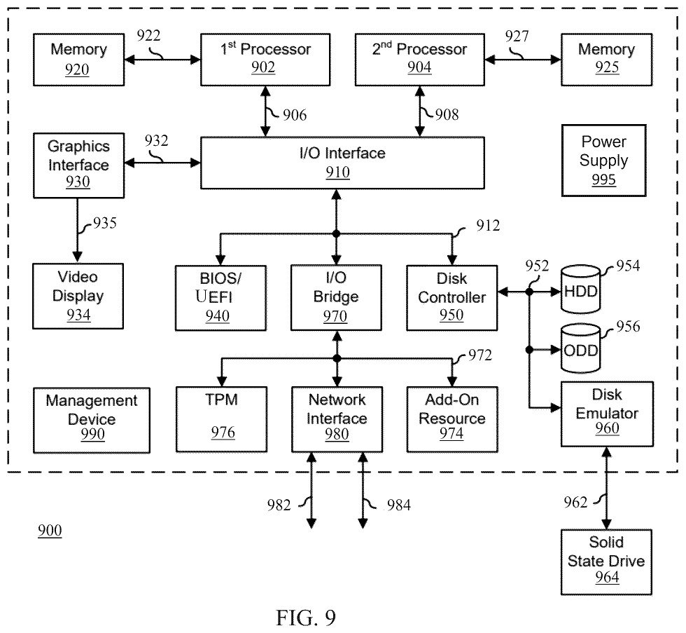

FIG. 9 shows a generalized embodiment of an information handling system 900 according to an embodiment of the present disclosure. Information handling system 900 may be a liquid-cooled information handling system, and the information handling system may be monitored for potential coolant leaks using a leak sensor such as that described with reference to FIGS. 1-7. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 900 can be a liquid-cooled personal computer, laptop computer, network server, network storage device, switch router or other network communication device, or any similar device and may vary in size, shape, performance, functionality, and price. Further, information handling system 900 can include processing resources for executing machine-executable code, such as a central processing unit (CPU), a programmable logic array (PLA), an embedded device such as a System-on-a-Chip (SoC), or other control logic hardware. Information handling system 900 can also include one or more computer-readable mediums for storing machine-executable code, such as software or data. Additional components of information handling system 900 can include one or more storage devices that can store machine-executable code, one or more communications ports for communicating with external devices, and various input and output (I/O) devices, such as a keyboard, a mouse, and a video display. Information handling system 900 can also include one or more buses operable to transmit information between the various hardware components.

Information handling system 900 can include devices or modules that embody one or more of the devices or modules described below and operates to perform one or more of the methods described below. Information handling system 900 includes a processors 902 and 904, an input/output (I/O) interface 910, memories 920 and 925, a graphics interface 930, a basic input and output system/universal extensible firmware interface (BIOS/UEFI) module 940, a disk controller 950, a hard disk drive (HDD) 954, an optical disk drive (ODD) 956, a disk emulator 960 connected to an external solid state drive (SSD) 964, an I/O bridge 970, one or more add-on resources 974, a trusted platform module (TPM) 976, a network interface 980, a management device 990, and a power supply 995. Processors 902 and 904, I/O interface 910, memory 920, graphics interface 930, BIOS/UEFI module 940, disk controller 950, HDD 954, ODD 956, disk emulator 960, SSD 964, I/O bridge 970, add-on resources 974, TPM 976, and network interface 980 operate together to provide a host environment of information handling system 900 that operates to provide the data processing functionality of the information handling system. The host environment operates to execute machine-executable code, including platform BIOS/UEFI code, device firmware, operating system code, applications, programs, and the like, to perform the data processing tasks associated with information handling system 900.

In the host environment, processor 902 is connected to I/O interface 910 via processor interface 906, and processor 904 is connected to the I/O interface via processor interface 908. Memory 920 is connected to processor 902 via a memory interface 922. Memory 925 is connected to processor 904 via a memory interface 927. Graphics interface 930 is connected to I/O interface 910 via a graphics interface 932 and provides a video display output 936 to a video display 934. In a particular embodiment, information handling system 900 includes separate memories that are dedicated to each of processors 902 and 904 via separate memory interfaces. An example of memories 920 and 930 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 940, disk controller 950, and I/O bridge 970 are connected to I/O interface 910 via an I/O channel 912. An example of I/O channel 912 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 910 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 940 includes BIOS/UEFI code operable to detect resources within information handling system 900, to provide drivers for the resources, initialize the resources, and access the resources. BIOS/UEFI module 940 includes code that operates to detect resources within information handling system 900, to provide drivers for the resources, to initialize the resources, and to access the resources.

Disk controller 950 includes a disk interface 952 that connects the disk controller to HDD 954, to ODD 956, and to disk emulator 960. An example of disk interface 952 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 960 permits SSD 964 to be connected to information handling system 900 via an external interface 962. An example of external interface 962 includes a USB interface, an IEEE 4394 (Firewire) interface, a proprietary interface, or a combination thereof. Alternatively, solid-state drive 964 can be disposed within information handling system 900.

I/O bridge 970 includes a peripheral interface 972 that connects the I/O bridge to add-on resource 974, to TPM 976, and to network interface 980. Peripheral interface 972 can be the same type of interface as I/O channel 912 or can be a different type of interface. As such, I/O bridge 970 extends the capacity of I/O channel 912 when peripheral interface 972 and the I/O channel are of the same type, and the I/O bridge translates information from a format suitable to the I/O channel to a format suitable to the peripheral channel 972 when they are of a different type. Add-on resource 974 can include a data storage system, an additional graphics interface, a network interface card (NIC), a sound/video processing card, another add-on resource, or a combination thereof. Add-on resource 974 can be on a main circuit board, on separate circuit board or add-in card disposed within information handling system 900, a device that is external to the information handling system, or a combination thereof.

Network interface 980 represents a NIC disposed within information handling system 900, on a main circuit board of the information handling system, integrated onto another component such as I/O interface 910, in another suitable location, or a combination thereof. Network interface device 980 includes network channels 982 and 984 that provide interfaces to devices that are external to information handling system 900. In a particular embodiment, network channels 982 and 984 are of a different type than peripheral channel 972 and network interface 980 translates information from a format suitable to the peripheral channel to a format suitable to external devices. An example of network channels 982 and 984 includes InfiniBand channels, Fibre Channel channels, Gigabit Ethernet channels, proprietary channel architectures, or a combination thereof. Network channels 982 and 984 can be connected to external network resources (not illustrated). The network resource can include another information handling system, a data storage system, another network, a grid management system, another suitable resource, or a combination thereof.

Management device 990 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 900. In particular, management device 990 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 900, such as system cooling fans and power supplies. Management device 990 can include a network connection to an external management system, and the management device can communicate with the management system to report status information for information handling system 900, to receive BIOS/UEFI or system firmware updates, or to perform other task for managing and controlling the operation of information handling system 900.

Management device 990 can operate off a separate power plane from the components of the host environment so that the management device receives power to manage information handling system 900 when the information handling system is otherwise shut down. An example of management device 990 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 990 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. A leak sensor for monitoring a liquid cooing assembly of an information handling system, the leak sensor comprising:
a flexible dielectric substrate;
a reference trace formed on the flexible dielectric substrate;
a first signal trace formed on the flexible substrate substantially in parallel with a first portion of the reference trace; and
a second signal trace formed on the flexible substrate substantially in parallel with a second portion of the reference trace;
wherein the first and second signal traces are separated by insulation into separate regions on the flexible dielectric substrate; and
wherein electrically driving the first and second signal traces induces voltages on the first and second signal traces, the voltages correlated with an amount of liquid within the separate regions.

2. The leak sensor of claim 1, wherein the reference trace, the first signal trace, and second signal trace are each configured in comb-like structures having multiple finger-like extensions; and wherein the finger-like extensions of the first signal trace and the second signal trace are interdigitated with, and spaced apart an equidistant from, the finger-like extensions of the reference trace.

3. The leak sensor of claim 1, wherein the first and second signal traces and the reference trace each extend along continuous serpentine paths that form a repeating pattern of extensions;
wherein each extension turns back on itself; and wherein the reference trace extensions alternate with the first and second signal trace extensions.

4. The leak sensor of claim 1, wherein the insulation is a solder mask.

5. The leak sensor of claim 1, wherein the first and second signal traces and the reference trace form a first layer of the flexible substrate, and further comprising a second layer that includes:
a second reference trace; and
third and fourth signal traces each substantially in parallel with separate portions of the second reference trace;
wherein the third and fourth signal traces are separated by insulation into separate regions on the second layer; and
wherein electrically driving the third and fourth signal traces induces voltages correlated with an amount of liquid within the separate regions on the second layer.

6. The leak sensor of claim 5, further comprising:
a middle layer, wherein the middle layer forms a ground plane.

7. The leak sensor of claim 1, further comprising:
a first moisture-wicking layer over the first signal trace and the first portion of the reference trace; and
a second moisture-wicking layer over the second signal trace and the second portion of the reference trace.

8. The leak sensor of claim 1, further comprising:
an active driver head operatively coupled with the first and second signals traces, wherein the active driver head is configured to electrically drive the first and second signal traces during operation of the leak sensor.

9. The leak sensor of claim 8, wherein the active driver head is configured to operatively couple with a Platform Infrastructure Connectivity Power (PICPWR) connector and is Data Center Modular Hardware System (DC-MHS) compliant to interface with a host processor module.

10. The leak sensor of claim 9, wherein the leak sensor operatively couples with one or more passive leak sensors to drive each passive leak sensor during operation.

11. A method of monitoring a liquid cooing assembly of an information handling system, the method comprising:
driving, with an alternating-current (AC) signal, a first signal trace and a second signal trace formed on a flexible dielectric substrate, wherein the first and second signal traces are each substantially parallel with a reference trace formed on the flexible substrate, and wherein the first and second signal traces are insulated in separate regions of the flexible dielectric substrate;
processing, by a signal processor, signals generated on the first and second signal traces in response to the AC signal; and
detecting, by the signal processor, a potential coolant leak in one of the separate regions in response to a change in magnitude of one of the signals generated on the first or second signal traces.

12. The method of claim 11, further comprising:
generating an alert in response to the detecting a potential coolant leak.

13. The method of claim 11, wherein the signals generated on the first and second signal traces represent impedances associated with the first and signal traces.

14. The method of claim 11, wherein the signals generated on the first and second signal traces represent capacitances associated with the first and signal traces.

15. An information handling system (IHS), comprising:
a chassis enclosing at least one processor;
a memory; and
a bus communicatively coupling the memory with the at least one processor;
a liquid cooling assembly positioned within the chassis;
a control unit positioned with the chassis; and
a leak sensor operatively coupled to the control unit, the leak sensor having
a flexible dielectric substrate;
a reference trace formed on the flexible dielectric substrate;
a first signal trace formed on the flexible substrate substantially in parallel with a first portion of the reference trace; and
a second signal trace formed on the flexible substrate substantially in parallel with a second portion of the reference trace;
wherein the first and second signal traces are separated by insulation into separate regions on the flexible dielectric substrate; and
wherein electrically driving the first and second signal traces induces voltages on the first and second signal traces, the voltages correlated with an amount of liquid within the separate regions.

16. The IHS of claim 15, wherein the reference trace, the first signal trace, and second signal trace of the leak sensor are each configured in comb-like structures having multiple finger-like extensions; and wherein the finger-like extensions of the first signal trace and the second signal trace are interdigitated with, and spaced apart an equidistant from, the finger-like extensions of the reference trace.

17. The IHS claim 15, wherein the first and second signal traces and the reference trace of the leak sensor each extend along continuous serpentine paths that form a repeating pattern of extensions; wherein each extension turns back on itself; and wherein the reference trace extensions alternate with the first and second signal trace extensions.

18. The IHS of claim 15, wherein the insulation of the leak sensor is a solder mask.

19. The IHS of claim 15, wherein the first and second signal traces and the reference traces of the leak sensor form a first layer of the flexible substrate, and wherein the leak sensor includes a second layer having
a second reference trace; and
third and fourth signal traces each substantially in parallel with separate portions of the reference trace;
wherein the third and fourth signal traces are separated by insulation into separate regions on the second layer; and
wherein electrically driving the third and fourth signal traces induces voltages correlated with an amount of liquid within the separate regions on the second layer

20. The IHS of claim 19, wherein the leak sensor further includes:
a middle layer, the middle layer forming a ground plane.
